(19) United States
(12) Patent Application Publication
(10) Pub. No.: US 2026/0035959 A1
(43) Pub. Date: Feb. 5, 2026

(54) Door Latch Shutter

(71) Applicant: Willo Products Company, LLC, Decatur, AL (US)

(72) Inventor: Brian S. Foss, Madison, AL (US)

(21) Appl. No.: 19/179,202

(22) Filed: Apr. 15, 2025

Related U.S. Application Data
(60) Provisional application No. 63/639,754, filed on Apr. 29, 2024.

(51) Int. Cl. E05B 17/20; E05B 55/00

(52) U.S. Cl. CPC E05B 17/2084; E05B 55/00

(57) ABSTRACT

A locking system includes a first housing, a lock bolt, and a shutter. The first housing defines an opening. The lock bolt is supported by the first housing and configured to move between an extended position and a retracted position. The shutter is supported by the first housing and configured to move between an uncovered position and a covered position. The shutter is in the uncovered position when the lock bolt is in the extended position. The shutter is in the covered position when the lock bolt is in the retracted position.

### CROSS-REFERENCE TO RELATED APPLICATION

This application claims the benefit of U.S. Provisional Application No. 63/639,754 filed Apr. 29, 2024, the entire disclosure of which is incorporated by reference.

### FIELD

The present disclosure relates to a tamper-resistant locking system for a door and, more particularly, to a locking system including a shutter for blocking an opening formed in a door or door frame.

### BACKGROUND

Door locking systems are essential components for securing doors at prisons and various other properties and facilities. These systems are typically attached to the exterior side of a door, allowing authorized individuals to access a room (a prison cell) on the interior side of the door, and preventing unauthorized individuals from opening the door and exiting the room on the interior side of the door. The security of these door locking systems can be compromised if the housing enclosing the locking system is susceptible to tampering or forced entry. For example, tampering with the door locking system or components thereof can prevent an aperture or opening formed in one of the door or a frame in which the door is received from receiving a lock bolt disposed on the other of the door or the frame or can prevent the lock bolt from extending into the aperture or opening formed in one of the door or the frame, which, in turn, can prevent the door from being secured in a closed position relative to the frame.

While known systems and methods for securing door locking systems may be acceptable for their intended purposes, there exists a continuous need in the pertinent art for an improved system and method for inhibiting tampering with a door locking system.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a locking system. The locking system includes a first housing, a lock bolt, and a shutter. The first housing defines an opening. The lock bolt is supported by the first housing and configured to move between an extended position and a retracted position. The shutter is supported by the first housing and configured to move between an uncovered position and a covered position. The shutter is in the uncovered position when the lock bolt is in the extended position. The shutter is in the covered position when the lock bolt is in the retracted position.

Another aspect of the disclosure provides a locking system. The locking system includes a lock bolt, a shutter, and a first actuation system. The lock bolt is configured to move between an extended position and a retracted position. The shutter is configured to move between an uncovered position and a covered position. The first actuation system is coupled to the lock bolt and the shutter and is configured to move between a first position and a second position. When the first actuation system moves from the first position to the second position, the first actuation system (i) moves the shutter from the uncovered position to the covered position and (ii) moves the lock bolt from extended position to the retracted position.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1A is a first perspective view of a door locking system according to the principles of the present disclosure.

FIG. 1B is a second perspective view of a housing of the door locking system of FIG. 1A according to the principles of the present disclosure.

FIG. 1C is a third perspective view of the door locking system of FIG. 1A according to the principles of the present disclosure.

FIG. 2A is a top plan view of the door locking system of FIG. 1A in a first orientation according to the principles of the present disclosure.

FIG. 2B is a top plan view of the door locking system of FIG. 1A in a second orientation according to the principles of the present disclosure.

FIG. 3A is a front view of the door locking system of FIG. 1A in the first orientation according to the principles of the present disclosure.

FIG. 3B is a front view of the door locking system of FIG. 1A in the second orientation according to the principles of the present disclosure.

In the drawings, reference numbers may be reused to identify similar and/or identical elements.

### DETAILED DESCRIPTION

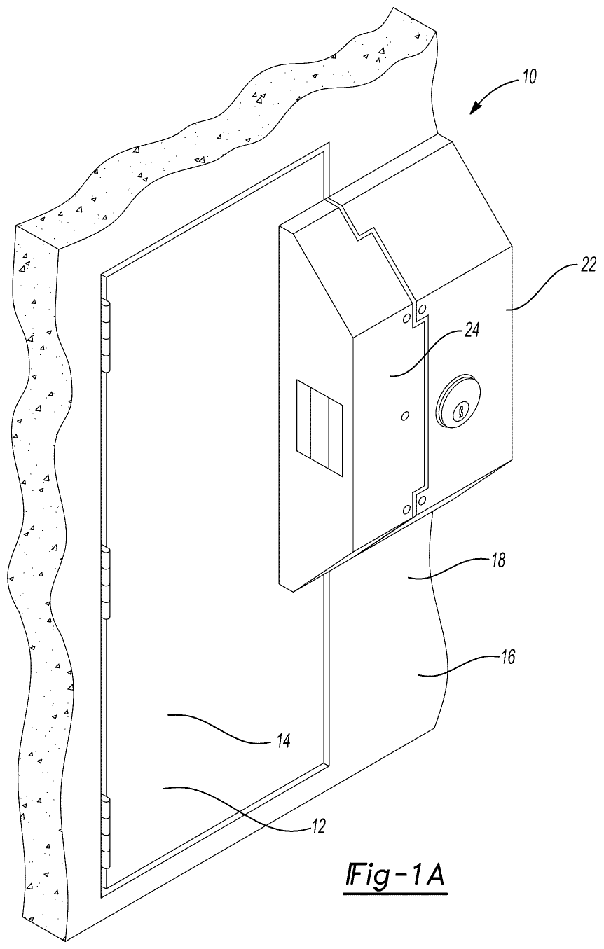

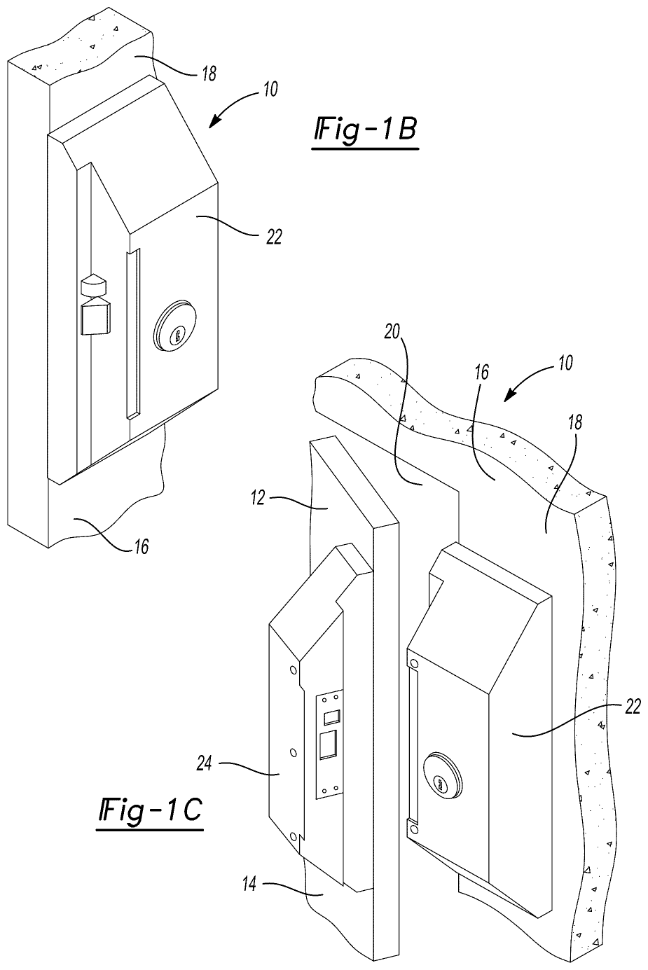

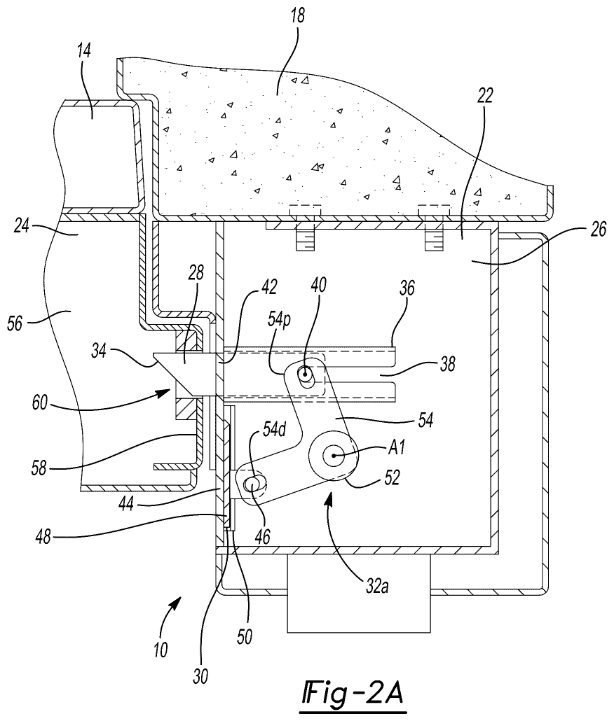

Referring to FIGS. 1A-1C, a lock system 10 is illustrated. As will be explained in more detail below, the lock system 10 may be mounted on an exterior surface 12 of a door 14 and an exterior surface 16 of a wall 18 to secure the door 14 in a closed orientation (FIG. 1A) relative to the wall 18. The door 14 may pivot (e.g., clockwise) relative to the wall 18 from an open orientation (FIG. 1C) to the closed orientation (FIG. 1A) to inhibit passage through an opening 20 defined by the door 14 and the wall 18. Conversely, the door 14 may pivot relative to the wall 18 from the closed orientation to the open orientation to allow passage through the opening 20.

The lock system 10 may include a first housing assembly 22 and a second housing assembly 24. While the first housing assembly 22 is generally shown and described herein as being mounted on the wall 18, and the second housing assembly 24 is generally shown and described herein as being mounted on the door 14, it will be appreciated that the first housing assembly 22 may be mounted on the door 14, and the second housing assembly 24 may be mounted on the wall 18 within the scope of the present disclosure. In some implementations, the first housing assembly 22 may be the door 14 or the wall 18, or be mounted within the door 14 or the wall 18, and the second housing assembly 24 may be the other of the door 14 or the wall 18, or be mounted within the other of the door 14 or the wall 18. In this regard, the door 14 may be the first housing assembly 22 or the second housing assembly 24, and the wall 18 may be the first housing assembly 22 or the second housing assembly 24.

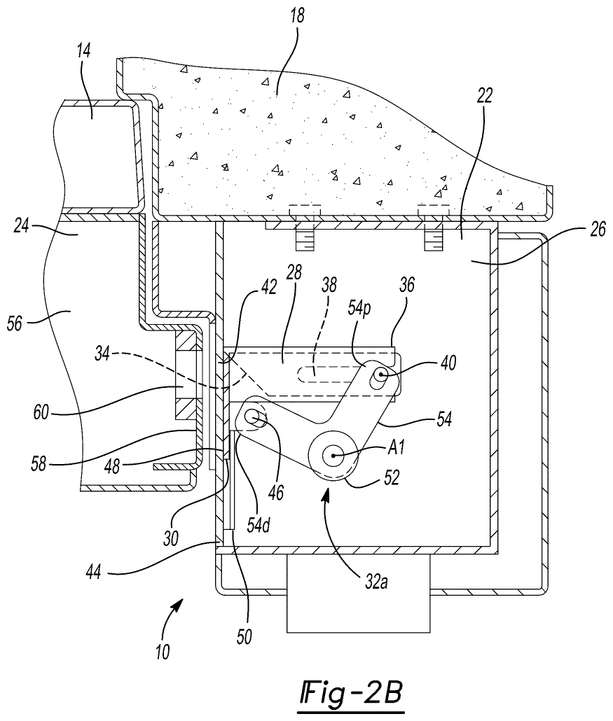

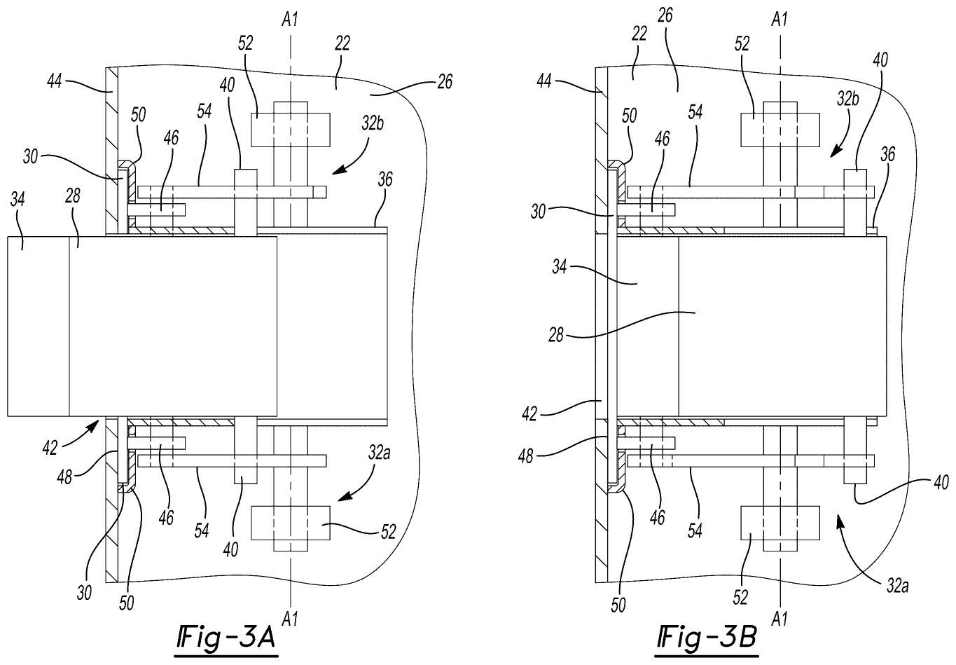

Referring now to FIGS. 2A-3B, the first housing assembly 22 may include a first housing 26, a lock bolt 28, a shutter 30, a first actuation system 32a, and a second actuation system 32b. The lock bolt 28, the shutter 30, the first actuation system 32a, and the second actuation system 32b may be disposed within the first housing 26.

As will be explained in more detail below, the first and/or second actuation systems 32a, 32b may be configured to facilitate movement of the lock bolt 28 between an extended position (FIG. 2A) and a retracted position (FIG. 2B). The first and/or second actuation systems 32a, 32b may also be configured to facilitate movement of the shutter 30 between an uncovered position (FIG. 2A) and a covered position (FIG. 2B). In some configurations, the first and/or second actuation systems 32a, 32b are configured to facilitate movement of the lock bolt 28 and the shutter 30 simultaneously. For example, in a method of operating the lock system 10, movement of the first actuation system 32a and/or the second actuation system 32b from a first position (FIG. 2A) to a second position (FIG. 2B) may move the lock bolt 28 from the extended position (FIG. 2A) to the retracted position (FIG. 2B), and/or may move the shutter 30 from the uncovered position (FIG. 2A) to the covered position (FIG. 2B).

In some implementations, the lock bolt 28 moves in a first direction between an extended position (FIG. 2A) and a retracted position (FIG. 2B) and the shutter 30 moves in a second direction between an uncovered position (FIG. 2A) and a covered position (FIG. 2B). The second direction may be transverse to the first direction. In some implementations, the second direction is perpendicular to the first direction.

As will be explained in more detail below, engagement of the lock bolt 28 with the second housing assembly 24 may actuate the first actuation system 32a and/or the second actuation system 32b from the first position (FIG. 2A) to the second position (FIG. 2B). Additionally, or alternatively, an individual (not pictured) may engage with (e.g., push in) the lock bolt 28, which may actuate the first actuation system 32a and/or the second actuation system 32b from the first position (FIG. 2A) to the second position (FIG. 2B). When the lock system 10 is in an open orientation (FIG. 1C), the lock bolt 28 may be in the extended position (FIG. 2A). When the lock system 10 is in the closed orientation (FIG. 1A), the lock bolt 28 may be in the retracted position (FIG. 2B).

The lock bolt 28 may be coupled to the first housing 26 and include a first end 34. For example, the first housing 26 may include a lock bolt guide 36 to which the lock bolt 28 is translatably-coupled and/or disposed. In some implementations, the lock bolt guide 36 is configured to support the lock bolt 28 within the first housing 26 when the lock bolt 28 is in the retracted position (FIG. 2B). The lock bolt guide 36 may include a slot 38. In some implementations, the lock bolt 28 includes a post 40 and the first actuation system 32a may be coupled to the post 40. The slot 38 may be configured to receive the post 40. For example, the post 40 may move (e.g., translate) within the slot 38 when the lock bolt 28 moves between the extended position (FIG. 2A) and the retracted position (FIG. 2B). The post 40 may be coupled to the lock bolt 28 and the first and/or second actuation systems 32a, 32b.

As will be explained in more detail below, during operation of the lock system 10, the lock bolt 28 may move between the extended position (FIG. 2A) and the retracted position (FIG. 2B). In the extended position (FIG. 2A), the lock bolt 28 may extend outside of the first housing 26. In the retracted position (FIG. 2B), the lock bolt 28 may be retracted within the first housing 26. In some implementations, the first end 34 of the lock bolt 28 is a tapered end.

The first housing 26 may define an opening 42 disposed on a first side 44 of the first housing 26. When the door 14 is in the closed orientation (FIG. 1A), the first side 44 of the first housing 26 may face the second housing assembly 24. The opening 42 may receive the lock bolt 28. In this regard, the opening 42 may be substantially the same shape and/or size as at least a portion of the lock bolt 28.

In some configurations, the opening 42 may be a rectangle. The opening 42 may be slightly larger than the lock bolt 28 to allow the lock bolt 28 to move (translate) freely through the opening 42. In some configurations, the opening 42 may be sized such that there is a zero or near zero clearance between the lock bolt 28 and the opening 42.

The shutter 30 may be coupled to the first housing 26 and include a post 46 and a first side 48. For example, the first housing 26 may include a shutter guide 50 to which the shutter 30 is translatably coupled. The shutter guide 50 may be disposed on the first side 44 of the first housing 26. In some implementations, the shutter guide 50 is configured to support the shutter 30 within the first housing 26 when the shutter 30 is in the uncovered position (FIG. 2A). In some implementations, the shutter 30 (the first side 48) may be substantially the same shape and/or size as at least a portion of the opening 42. The shutter 30 (e.g., the first side 48) may be slightly larger than the opening 42 to completely cover (e.g., block) the opening 42 when the shutter is in the covered position (FIG. 2B). As will be explained in more detail below, during operation of the lock system 10, the shutter 30 may move between the uncovered position (FIG. 2A) and the covered position (FIG. 2B). In the uncovered position (FIG. 2A), the lock bolt 28 may retracted within the first housing 26 and not blocking the opening 42. In the covered position (FIG. 2B), the shutter 30 (e.g., the first side 48) may at least partially cover (e.g., block) the opening 42. In some implementations, the first actuation system 32a is coupled to the post 46.

The first actuation system 32a may include a rotation feature 52 coupled to the first housing 26 and a linkage 54. The linkage 54 may be coupled (e.g., rotatably-coupled) to the rotation feature 52. The linkage 54 may include a proximal end 54p and a distal end 54d. The linkage 54 (e.g., the proximal end 54p) may be rotatably coupled to the lock bolt 28 (e.g., the post 40). The linkage 54 (e.g., the distal end 54d) may be further rotatably coupled to the shutter 30 (e.g., the post 46). The rotation feature 52 may define a first axis of rotation A1.

As the lock bolt 28 is forced (e.g., by the second housing assembly 24 or an individual) into the first housing 26, the linkage 54 may rotate in a clockwise direction about the first axis of rotation A1 and force the shutter 30 (e.g., the first side 48) to move over the opening 42 and into the covered position (FIG. 2B).

When force is no longer applied to the lock bolt 28, the lock bolt may extend outside of the first housing 26, forcing the linkage 54 to rotate in a counterclockwise direction about the first axis of rotation A1 and force the shutter 30 to uncover the opening 42 and retract within the first housing 26 (e.g., within the shutter guide 50).

The second actuation system 32b may include components (e.g., a rotation feature 52 and a linkage 54) having a similar structure and function as those described above relative to the first actuation system 32a. In view of the similarity in structure and function of the first actuation system 32a and the second actuation system 32b, the second actuation system 32b will not be separately described herein, and the description of the first actuation system 32a will be understood to apply equally to the second actuation system 32b except as otherwise noted. In some implementations, the linkage 54 of the first actuation system 32a may be coupled (e.g., rotatably coupled) to the linkage 54 of the second actuation system 32b. For example, the linkage 54 may be coupled by a shared rotation feature 52. In this way, the first actuation system 32a and the second actuation system 32b may simultaneously move from the first position (FIG. 2A) to the second position (FIG. 2B).

The second housing assembly 24 may include a second housing 56 defining a first side 58 and an opening 60. In some configurations, the opening 60 is disposed on the first side 58. When the door 14 is in the closed orientation (FIG. 1A), the first side 58 of the second housing 56 may face the first housing assembly 22. The opening 60 may be configured to receive the lock bolt 28. For example, when the door 14 is in the closed orientation (FIG. 1A), the lock bolt 28 may be disposed within the opening 60 of the second housing 56, and may secure the position of the first housing assembly 22 relative to the second housing assembly 24 when the door 14 is in the closed orientation (FIG. 1A). As the door 14 moves from the open orientation (FIG. 1C) to the closed orientation (FIG. 1A) the first side 58 of the second housing 56 may engage the lock bolt 28 (e.g., the first end 34 of the lock bolt 28).

A first method of operating a lock system (e.g., the lock system 10) will now be described with reference to FIGS. 1A-3B. In a step of operating the lock system 10, the door 14 is moved from the open orientation (FIG. 1C) to the closed orientation (FIG. 1A). In the open orientation, the first housing assembly 22 is spaced apart from the second housing assembly 24, and the lock bolt 28 may extend outside the first housing 26. For example, the lock bolt 28 may extend beyond the first side 44.

As the door 14 moves from the open orientation to the closed orientation, the first housing assembly 22 may contact the second housing assembly 24. For example, the first side 58 of the second housing 56 may engage (e.g., translate across) the lock bolt 28 (e.g., the first end 34 of the lock bolt 28). As the first side 58 of the second housing 56 moves along the lock bolt 28 (e.g., the first end 34 of the lock bolt 28), the first side 58 of the second housing 56 may push the lock bolt 28 into the first housing 26. The movement of the lock bolt 28 into the first housing 26 may, in turn move the first actuation system 32a. For example, movement of the lock bolt 28 may cause the linkage 54 to rotate (e.g., clockwise) about the axis A1. Rotation of the linkage 54 may cause the shutter 30 to move (e.g., translate) in front of the opening 42 of the first housing 26. In some configurations, the shutter 30 may maintain contact with the lock bolt 28 (e.g., the first end 34 of the lock bolt 28) such that the opening 42 of the first housing 26 stays completely blocked throughout operation of the lock system 10.

In configurations with the second actuation system 32b, the movement of the second actuation system 32b is similar to the movement of the first actuation system 32a, described above. Movement of the first actuation system 32a and the second actuation system 32b may occur simultaneously.

When the lock system 10 reaches the closed orientation, the shutter 30 moves (e.g., translates) uncovering the opening 42 of the first housing 26. The movement of the shutter 30 may cause the linkage 54 to rotate (e.g., counterclockwise) about the axis A1. Rotation of the linkage 54 may cause the lock bolt to move (e.g., translate) and extend through the opening 42 of the first housing 26 and into the opening 60 of the second housing 56.

A second method of operating a lock system (e.g., the lock system 10) will now be described with reference to FIGS. 1A-3B. In a step of operating the lock system 10, when the door 14 is in the open orientation (FIG. 1C), an individual may engage (e.g., push in) the lock bolt 28 (e.g., the first end 34 of the lock bolt 28). The movement of the lock bolt 28 into the first housing 26 may, in turn move the first actuation system 32a. For example, movement of the lock bolt 28 may cause the linkage 54 to rotate (e.g., clockwise) about the axis A1. Rotation of the linkage 54 may cause the shutter 30 to move (e.g., translate) in front of the opening 42 of the first housing 26. In some configurations, the shutter 30 may maintain contact with the lock bolt 28 (e.g., the first end 34 of the lock bolt 28) such that the opening 42 of the first housing 26 stays completely blocked throughout operation of the lock system 10.

In configurations with the second actuation system 32b, the movement of the second actuation system 32b is similar to the movement of the first actuation system 32a, described above. Movement of the first actuation system 32a and the second actuation system 32b may occur simultaneously.

The configuration and operation of the lock system 10 described herein can prevent an individual (e.g., an inmate) from forcing items (e.g., contraband) into the opening 42 of the first housing 26 when the door 14 is in the open orientation (FIG. 1C), thus ensuring that the lock bolt 28 can extend through the opening 42 of the first housing 26 and into the opening 60 of the second housing 56 enabling a secure locking of the door 14 when the lock system 10 is in the closed position (FIG. 1A).

The following Clauses provide an exemplary configuration for a lock system, as described above.

Clause 1: A locking system comprising: a first housing defining an opening; a lock bolt supported by the first housing and configured to move between an extended position and a retracted position; and a shutter supported by the first housing and configured to move between an uncovered position and a covered position, wherein the shutter is in the uncovered position when the lock bolt is in the extended position, and the shutter is in the covered position when the lock bolt is in the retracted position.

Clause 2: The locking system of clause 1, wherein the shutter blocks the opening when the shutter is in the covered position.

Clause 3: The locking system of any of clauses 1 through 2, further comprising a first actuation system coupled to the lock bolt and the shutter, the first actuation system configured to move between a first position and a second position.

Clause 4: The locking system of clause 3, wherein the first actuation system moves the shutter from the uncovered position to the covered position when the first actuation system moves from the first position to the second position.

Clause 5: The locking system of clause 4, further comprising a second actuation system coupled to the lock bolt and the shutter, the second actuation system configured to move between a third position and a fourth position.

Clause 6: The locking system of clause 5, wherein the second actuation system moves the shutter from the uncovered position to the covered position when the second actuation system moves from the third position to the fourth position.

Clause 7: The locking system of clause 3, wherein the first actuation system includes a linkage coupled to the lock bolt and the shutter.

Clause 8: The locking system of clause 7, wherein the linkage is rotatably coupled to the lock bolt and the shutter and configured to move the shutter between the uncovered position and the covered position when the lock bolt moves between the extended position and the retracted position.

Clause 9: The locking system of any of clauses 1 through 8, wherein the first housing further comprises a guide configured to support the lock bolt when the lock bolt is in the retracted position.

Clause 10: The locking system of any of clauses 1 through 9, further comprising a second housing including a first side configured to engage the lock bolt.

Clause 11: The locking system of clause 10, wherein the second housing is operable to move the lock bolt from the extended position to the retracted position when the first side engages the lock bolt.

Clause 12: A locking system comprising: a lock bolt configured to move between an extended position and a retracted position; a shutter configured to move between an uncovered position and a covered position; and a first actuation system coupled to the lock bolt and the shutter and configured to move between a first position and a second position, wherein, when the first actuation system moves from the first position to the second position, the first actuation system (i) moves the shutter from the uncovered position to the covered position and (ii) moves the lock bolt from extended position to the retracted position.

Clause 13: The locking system of clause 12, further comprising a first housing defining an opening, wherein the lock bolt, the shutter, and the first actuation system are supported by the first housing.

Clause 14: The locking system of clause 13, wherein the shutter blocks the opening when the shutter is in the covered position.

Clause 15: The locking system of any of clauses 12 through 14, further comprising a second actuation system coupled to the lock bolt and the shutter, the second actuation system configured to move between a third position and a fourth position.

Clause 16: The locking system of any of clauses 12 through 15, wherein the second actuation system moves the shutter from the uncovered position to the covered position when the second actuation system moves from the third position to the fourth position.

Clause 17: The locking system of any of clauses 13 through 16, wherein the first housing further comprises a guide configured to support the lock bolt when the lock bolt is in the retracted position.

Clause 18: The locking system of any of clauses 12 through 17, wherein the first actuation system includes a linkage coupled to the lock bolt and the shutter.

Clause 19: The locking system of clause 18, wherein the linkage is rotatably coupled to the lock bolt and the shutter and configured to move the shutter between the uncovered position and the covered position when the lock bolt moves between the extended position and the retracted position.

Clause 20: The locking system of any of clauses 12 through 20, further comprising a second housing including a first side configured to engage the lock bolt, wherein the second housing is operable to move the lock bolt from the extended position to the retracted position when the first side engages the lock bolt.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (“between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A locking system comprising:
a first housing defining an opening;
a lock bolt supported by the first housing and configured to move between an extended position and a retracted position; and
a shutter supported by the first housing and configured to move between an uncovered position and a covered position,
wherein the shutter is in the uncovered position when the lock bolt is in the extended position, and the shutter is in the covered position when the lock bolt is in the retracted position.

2. The locking system of claim 1, wherein the shutter blocks the opening when the shutter is in the covered position.

3. The locking system of claim 1, further comprising a first actuation system coupled to the lock bolt and the shutter, the first actuation system configured to move between a first position and a second position.

4. The locking system of claim 3, wherein the first actuation system moves the shutter from the uncovered position to the covered position when the first actuation system moves from the first position to the second position.

5. The locking system of claim 4, further comprising a second actuation system coupled to the lock bolt and the shutter, the second actuation system configured to move between a third position and a fourth position.

6. The locking system of claim 5, wherein the second actuation system moves the shutter from the uncovered position to the covered position when the second actuation system moves from the third position to the fourth position.

7. The locking system of claim 3, wherein the first actuation system includes a linkage coupled to the lock bolt and the shutter.

8. The locking system of claim 7, wherein the linkage is rotatably coupled to the lock bolt and the shutter and configured to move the shutter between the uncovered position and the covered position when the lock bolt moves between the extended position and the retracted position.

9. The locking system of claim 1, wherein the first housing further comprises a guide configured to support the lock bolt when the lock bolt is in the retracted position.

10. The locking system of claim 1, further comprising a second housing including a first side configured to engage the lock bolt.

11. The locking system of claim 10, wherein the second housing is operable to move the lock bolt from the extended position to the retracted position when the first side engages the lock bolt.

12. A locking system comprising:
a lock bolt configured to move between an extended position and a retracted position;
a shutter configured to move between an uncovered position and a covered position; and
a first actuation system coupled to the lock bolt and the shutter and configured to move between a first position and a second position,
wherein, when the first actuation system moves from the first position to the second position, the first actuation system (i) moves the shutter from the uncovered position to the covered position and (ii) moves the lock bolt from extended position to the retracted position.

13. The locking system of claim 12, further comprising a first housing defining an opening, wherein the lock bolt, the shutter, and the first actuation system are supported by the first housing.

14. The locking system of claim 13, wherein the shutter blocks the opening when the shutter is in the covered position.

15. The locking system of claim 14, further comprising a second actuation system coupled to the lock bolt and the shutter, the second actuation system configured to move between a third position and a fourth position.

16. The locking system of claim 15, wherein the second actuation system moves the shutter from the uncovered position to the covered position when the second actuation system moves from the third position to the fourth position.

17. The locking system of claim 13, wherein the first housing further comprises a guide configured to support the lock bolt when the lock bolt is in the retracted position.

18. The locking system of claim 12, wherein the first actuation system includes a linkage coupled to the lock bolt and the shutter.

19. The locking system of claim 18, wherein the linkage is rotatably coupled to the lock bolt and the shutter and configured to move the shutter between the uncovered position and the covered position when the lock bolt moves between the extended position and the retracted position.

20. The locking system of claim 12, further comprising a second housing including a first side configured to engage the lock bolt, wherein the second housing is operable to move the lock bolt from the extended position to the retracted position when the first side engages the lock bolt.
